(19) United States
(12) Patent Application Publication
(10) Pub. No.: US 2026/0073803 A1
(43) Pub. Date: Mar. 12, 2026

(54) INFORMATION PROCESSING APPARATUS, INFORMATION PROCESSING METHOD, AND PROGRAM

(71) Applicant: Sony Group Corporation, Tokyo (JP)

(72) Inventor: Andreas GEIER, Tokyo (JP)

(73) Assignee: Sony Group Corporation, Tokyo (JP)

(21) Appl. No.: 19/125,318

(22) PCT Filed: Oct. 25, 2023
(86) PCT No.: PCT/JP2023/038463

§ 371 Date: Apr. 29, 2025

(30) Foreign Application Priority Data
Nov. 7, 2022 (JP) 2022-178288

(51) Int. Cl. G09B 5/06

(52) U.S. Cl. CPC G09B 5/06

(57) ABSTRACT

The present technology makes it possible to efficiently and quantitatively implement training for a human apprentice to learn a policy of an expert. An information processing apparatus includes processing circuitry configured to receive information corresponding to actions of a task by a first human, generate feedback by using a framework of imitation learning, the feedback indicating changes to the received actions of the task, the indicated changes being based on actions of a second human performing the task, and output information corresponding to the feedback to the first human who is performing the actions of the task.

### TECHNICAL FIELD

The present technology particularly relates to an information processing apparatus, an information processing method, and a program capable of efficiently and quantitatively implementing training for a human apprentice to learn a policy of an expert.

### CROSS REFERENCE TO RELATED APPLICATIONS

This application claims the benefit of Japanese Priority Patent Application JP 2022-178288 filed on Nov. 7, 2022, the entire contents of which are incorporated herein by reference.

### BACKGROUND ART

In order for the apprentice to acquire skills related to certain tasks possessed by an expert, such as cooking skills, competing skills, and gaming skills, it is usually necessary for the expert to directly teach his/her way to the apprentice by using words and gestures.

Learning for acquiring skills is advanced by the expert who evaluates skills of the apprentice and gives advice or guidance according to a subjective evaluation result to the apprentice as feedback. Since a quantitative evaluation is difficult, a good or bad learning quality greatly affects competence of the expert.

Furthermore, one expert usually can teach only a small number of apprentices such as two or three at the same time. Moreover, during the learning, since the expert needs to provide feedback to the apprentice each time, it is difficult to continuously perform real-time coaching.

Meanwhile, in recent years, research and development of imitation learning have been advanced. The imitation learning is a method of learning a policy of a robot or an agent by acquiring a policy that can reproduce the same actions as actions of the expert on the basis of an action time series (a trajectory) in which the actions of the expert and the like are observed.

### CITATION LIST

### Non Patent Literature

NPL 1: Imitation Learning: Progress, Taxonomies and Challenges. Zheng et al. 2022.
NPL 2: Imitation Learning as f-Divergence Minimization. Ke et al. 2020.
NPL 3: Learning by Cheating. Chen et al. 2019.
NPL 4: Global Overview of Imitation Learning. Attia et al. 2018.
NPL 5: A Reduction of Imitation Learning and Structured Prediction to No-Regret Online Learning. Ross et al. 2011.
NPL 6: Alvinn: An Autonomous Land Vehicle in a Neural Network. Pomerleau. 1988.

### SUMMARY OF INVENTION

### Technical Problem

In a case where conventional imitation learning for a robot or an agent is applied to learning of an actual human apprentice, it may be certainly impossible to directly perform the application, since it may be impossible to observe the policy of the apprentice by, for example, a computer.

In other words, since actions of the apprentice are expressed by decision making in a brain and a way of moving a body of the apprentice, it is necessary to access the brain and the body as a basis of action generation to observe the policy and adjust parameters constituting the policy in order to apply the conventional imitation learning.

The present technology has been made in view of such situation, and makes it possible to efficiently and quantitatively implement the training for the human apprentice to learn the policy of the expert.

### Solution to Problem

An information processing apparatus includes processing circuitry configured to receive information corresponding to actions of a task by a first human, generate feedback by using a framework of imitation learning, the feedback indicating changes to the received actions of the task, the indicated changes being based on actions of a second human performing the task, and output information corresponding to the feedback to the first human who is performing the actions of the task.

In an aspect of the present technology, the actions of the predetermined task by a human apprentice are observed, and the feedback for bringing the actions of the apprentice close to the actions of an expert is generated by using a framework of the imitation learning, and output to the apprentice performing the actions of the predetermined task.

### BRIEF DESCRIPTION OF DRAWINGS

FIG. 1 is a diagram illustrating an example of learning by an agent.

FIG. 2 is a diagram illustrating a modeled imitation learning in FIG. 1.

FIG. 3 is a diagram illustrating an example of training by an apprentice.

FIG. 4 is a diagram illustrating modeled imitation learning in FIG. 3.

FIG. 5 is a diagram illustrating an example of a sensor.

FIG. 6 is a diagram illustrating an example of a feedback device.

FIG. 7 is a diagram illustrating a first learning example for an apprentice.

FIG. 8 is a diagram illustrating a second learning example for the apprentice.

FIG. 9 is a diagram illustrating a third learning example for the apprentice.

FIG. 10 is a diagram illustrating an example of a DPL algorithm.

FIG. 11 is a diagram illustrating an application example of learning using the DPL.

FIG. 12 is an enlarged diagram illustrating a screen display.

FIG. 13 is a diagram illustrating another configuration example of a TQA system.

FIG. 14 is a block diagram illustrating a configuration example of a computer.

### DESCRIPTION OF EMBODIMENTS

Hereinafter, embodiments for carrying out the present technology will be described. The description will be given in the following order.
1. Overview of present technology
2. Learning of policy π_{φ}* by agent
3. Learning of policy π_{φ}* by human apprentice
4. Configuration of TQA system
5. First learning example (example to which BC is applied)
6. Second learning example (example to which DPL is applied)
7. Third learning example (example to which IRL is applied)
8. Details of feedback generation
9. Specific example of learning algorithm
10. Application example of learning using DPL

### Overview of Present Technology

### TQA System

A training and quality assurance (TQA) system to which the present technology is applied is a human participation type system using a framework of the imitation learning. In the TQA system, training for bringing actions related to a certain task close to actions of an expert is performed on a human apprentice.

Accordingly, the apprentice performing the training is a human. On the other hand, the expert may be a human, or may be an agent. The agent is implemented in a computer by executing a predetermined program.

In the TQA system, a plurality of sensors for continuously observing the actions of the apprentice is used. The sensors include not only a physically prepared sensor such as a camera but also a virtual sensor. The virtual sensor is implemented by, for example, a module inside the computer that observes states and actions generated in response to calculation by the computer.

Furthermore, in the TQA system, a feedback device for providing feedback to the apprentice is used. The feedback is provided to modify the actions of the apprentice. In a case where the expert is a human, the feedback is also provided to the expert as appropriate.

With the TQA system, a closed-loop type system is achieved for transferring skills related to a predetermined task possessed by the expert from the expert to the apprentice. In a case where it is determined that the apprentice has acquired the skills of the expert, the training ends.

A skill proficiency level of the apprentice is determined on the basis of a TQA evaluation value as an evaluation value defined in the TQA system. The skills mentioned here include various abilities of a person that affects actions, such as knowledge possessed by the person, abilities to make situational decisions, decision-making on the basis of the knowledge and results of the situational decisions, and a way to move a body in response to the decision-making. Skills related to a task involving actions are expressed as a policy (a measure) in the imitation learning.

Accordingly, in the TQA system, the TQA evaluation value is defined as a value quantified by comprehensively using, for example, a detection result by sensors instead of an abstract evaluation such as a subjective word.

The detection by the sensor is performed, for example, when the action time series (the trajectory) of at least either the expert or the apprentice is recorded.

The action time series of the apprentice is expressed as in the following expression (1). Furthermore, the action time series of the expert is expressed as the following expression (2). “a” indicates an action, and “o” indicates an observation value of a state of an environment in which the action is performed.

$$\begin{matrix}[ Math . 1 ] & \\ {[ y := ( a , o ) ]}_{θ} & ( 1 )\end{matrix}$$

$$\begin{matrix}[ Math . 2 ] & \\ {[ y := ( a , o ) ]}_{ϕ} & ( 2 )\end{matrix}$$

In the TQA system, π₀ (o) as a policy of the apprentice and π_{φ}* (o) as a policy of the expert are determined. A policy π₀ (o) and a policy π_{φ}* (o) enable deterministic or statistical distance query, analysis, and calculation. Hereinafter, the policy of the apprentice is indicated as π₀, and the policy of the expert is indicated as π_{φ}* as appropriate.

In the TQA system, feedback as a stimulus to a sense of a person such as the apprentice is generated for every time t. A feedback fₜ representing content of the feedback at each time t is determined, for example, on the basis of a difference between an action aₜ* as an action of the expert and an action aₜ as an action of the apprentice. Hereinafter, each piece of information will be described with an index t representing time omitted as appropriate.

A feedback f is determined by, for example, the following expression (3) by using an action a* and an action a. π₀ (o) represents an action a in an environment represented by an observation value o.

$$\begin{matrix}[ Math . 3 ] & \\ f = F ( {a}^{*} , {π}_{θ} ( 0 ) ) & ( 3 )\end{matrix}$$

Furthermore, by applying the policy π₀ (o) and the policy π_{φ}* (o) to a measurement method D, a TQA evaluation value d is determined as an evaluation value of a quantitative distance. The measurement method D is represented as a function of the following (4).

$$\begin{matrix}[ Math . 4 ] & \\ D [ Q ( {π}_{ϕ}^{*} ( {o}_{t} ) ) ‖ Q ( {π}_{θ} ( {o}_{t} ) ) ] & ( 4 )\end{matrix}$$

As the deterministic or statistical distance measurement method D, for example, Kullback-Leibler (KL) divergence or Jensen-Shannon (JS) divergence is used. “Q” is a function optionally selected by a user, such as a probability distribution function according to the policy.

Note that the action a in an action space A is observed as information constituting a part of the observation value o in an observation space O. On the basis of the detection result by the sensors, the action a of the expert or the apprentice is observed together with the observation value o. A sensor for observing the action a and a sensor for observing the observation value o may be prepared separately, and the action a and the observation value o representing a state of the environment may be respectively obtained on the basis of the detection results by different sensors.

Accordingly, the framework of the imitation learning that observes the actions of the expert and the apprentice by using a plurality of sensors and calculates respective distances can be used to generate the feedback, therefore, the training for the human apprentice can be implemented. As the feedback is continuously provided during training to bring the action a of the apprentice close to the action a* of the expert, the policy of the apprentice will be improved to be close to the policy of the expert.

Furthermore, it is possible to cause the expert to understand detailed performance of the training for the apprentice on the basis of, for example, an action time series y.

As for sensors

In an environment in which the expert and the apprentice performs actions, a plurality of sensors used to observe the actions of each of the expert and the apprentice as well as states of the environment are disposed. These sensors include various sensors such as a multimodal sensor in addition to a camera and a microphone.

For example, the sensors are disposed at predetermined locations in rooms where the expert and the apprentice are located. Furthermore, a wearable sensor is worn on the body of the expert or the apprentice, and used to observe, for example, the actions.

It is also possible to use the virtual sensor instead of a physical sensor. The virtual sensor includes, for example, a detection module provided in a game engine or a physical simulator. Various actions and states generated in response to calculation by the game engine or the physics simulator are observed by the virtual sensor.

As for feedback device

The feedback device is prepared in the environment in which the expert and the apprentice perform actions. The feedback device is used to cause the apprentice to recognize a case where the apprentice performs actions that are not optimal from a viewpoint of the TQA evaluation value. By receiving feedback from the feedback device, the apprentice will adjust his/her actions to bring them close to optimal actions.

The feedback is provided to both the apprentice and the expert as appropriate. Feedback for the human expert is provided, for example, to enable the expert to confirm contents of feedback received by the apprentice. Feedback with the same contents as the feedback received by the apprentice may be provided to the expert, or different feedback may be provided to the expert.

The feedback device includes a direct feedback device and an indirect feedback device.

The direct feedback device is, for example, a device configured to give a physical stimulus or an electrical stimulus to the body of the apprentice or the expert. A device configured to provide information to a sense of touch of human is the direct feedback device. A device configured to provide information to a sense of taste may be prepared as the direct feedback device.

The direct feedback device includes a device that generates vibrations or a device that generates weak electricity to move muscles of a person in any direction. For example, a glove type device to be worn on a hand, a wristband type device to be worn on a wrist, a hat type device to be worn on a head, or a vest type device to be worn on an upper body are prepared as the direct feedback device.

On the other hand, the indirect feedback device is a device configured to provide information to a sense of sight, a sense of hearing, and a sense of smell of a person without giving a physical stimulus to the body.

The indirect feedback device includes a display for providing information to the sense of sight by displaying images or a character, a speaker for providing information to the sense of hearing by outputting a sound, and a scent generation device for providing information to the sense of smell by generating a scent. The indirect feedback device may be disposed at a predetermined location in an environment such as a room, or may be prepared as a wearable device such as a goggle type device or an earphone.

The feedback device includes a wearable device (a first device) to be worn on a body and a device (a second device) disposed in, for example, a space where the training is performed. For example, the direct feedback device configured to provide information to the sense of touch of the person is included in at least one of the first device or the second device.

Accordingly, a system capable of receiving training using the quantitative evaluation is achieved by the TQA system utilizing the framework of the imitation learning. Since the quantitative evaluation is used and correspondent feedback is provided, the apprentice can be trained in a standard manner rather than in a personal manner.

In other words, the TQA system to which the present technology is applied is a system capable of guaranteeing the quality of the training for the human apprentice to learn the policy of the expert.

Furthermore, a plurality of the apprentices can be trained without limitation of the number of persons. The training can be performed in real time and continuously.

### <Learning of Policy π_{φ}* by Agent>

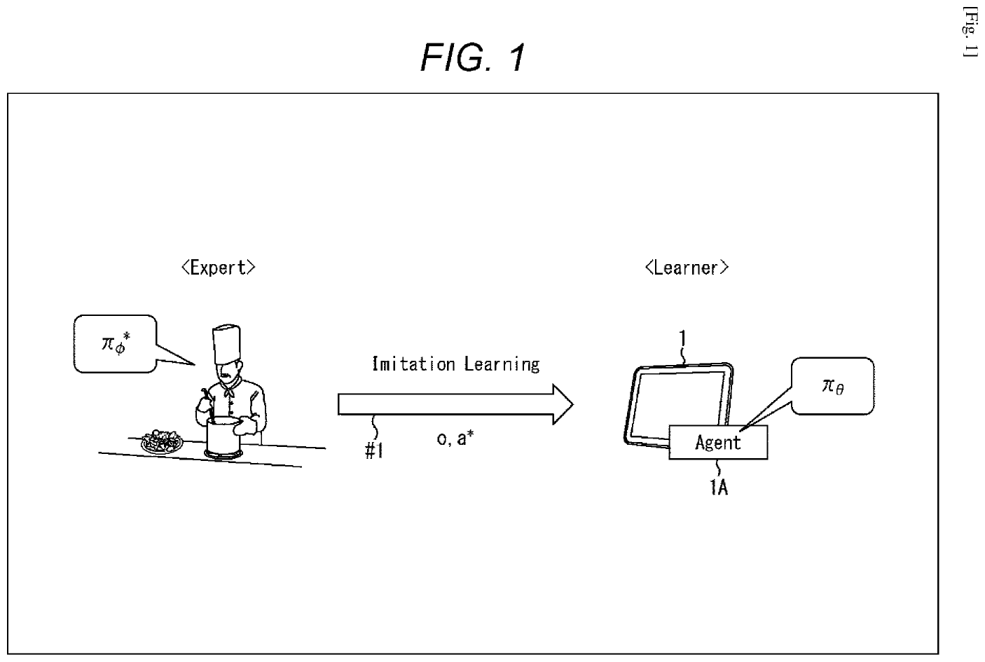

FIG. 1 is a diagram illustrating the example of learning by the agent.

In the example of FIG. 1, a human chef is illustrated as the expert. A policy to cause the agent to learn is a policy of the chef who completes a certain dish. The policy of the chef is represented as π_{φ}* as illustrated in a balloon of FIG. 1. A task is a cooking action for completing the certain dish.

Learning for causing the agent to acquire the policy π_{φ}* related to a predetermined task possessed by the expert is performed before the training for the human apprentice.

Hereinafter, a case where the expert is the chef will be mainly described, but it is possible to set various persons having the skills related to the task involving actions as the expert. For example, players in sports such as baseball and soccer, artists such as painters and sculptors, musicians playing musical instruments, and artisans such as potters can be the experts. Furthermore, various professionals such as a driving professional of a movable body such as a car, a cleaning professional, and a care professional can be the experts.

As described later, an AI agent playing a model game can also be the expert. In other words, the TQA system can be applied not only to actions of a person observed in an actual space but also to the case of learning a skill related to an action generated in response to the calculation by the computer. The expert may be one person, or may be a plurality of persons.

In the example of FIG. 1, an agent 1A installed in an information processing apparatus 1 as a tablet terminal is illustrated as a learner. The information processing apparatus 1 may be prepared in the same space as a space where the expert is cooking, or may be prepared in a different space.

In a case where the expert chef performs a cooking action as a demonstration, the observation value o representing a state of an environment in which the expert is cooking and the action a* of the expert are observed. Information on the observation value o and the action a* is supplied to the information processing apparatus 1 as indicated by an arrow #1, and the imitation learning for bringing the policy π_{φ} of the agent 1A close to the policy π_{φ}* of the expert is performed.

Note that various sensors such as a camera and a microphone are disposed in the environment in which the expert is cooking. The observation value o and the action a* are observed by applying various types of signal processing to sensor data detected by the sensors, and information representing the content is supplied to the information processing apparatus 1.

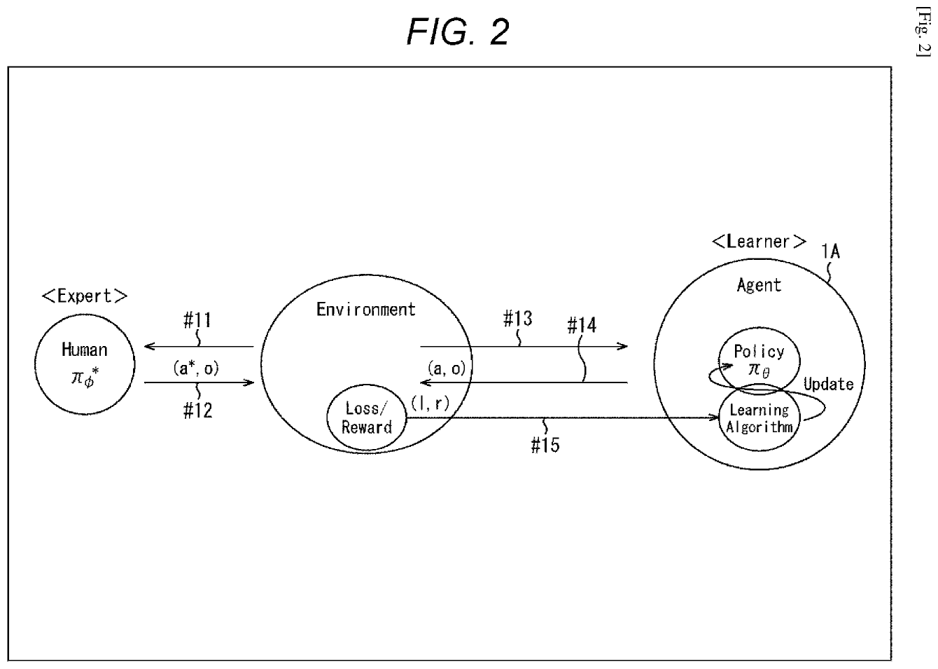

FIG. 2 is a diagram illustrating the modeled imitation learning in FIG. 1.

A circle on a left side of FIG. 2 represents the expert, and a center circle represents the environment in which the expert is cooking. A circle on a right side represents the agent 1A as a learner.

In response to the expert cooking in an environment provided as indicated by an arrow #11, the action a* and the observation value o of the expert are observed as indicated by an arrow #12. The action a* of the expert is an action performed in an environment indicated by the observation value o on the basis of the policy to π_{φ}*. By repeatedly observing the action a* and the observation value o, time series data of a pair of the action a* and the observation value o is obtained and recorded as the action time series of the expert.

Similarly, the agent 1A generates an action in an environment provided as indicated by an arrow #13. Generation of the action a of the agent 1A is performed to generate the action in the environment indicated by the observation value o on the basis of the policy π₀ being currently acquired by the agent 1A. The action a is a virtual action calculated by the computer. The action a and the observation value o of the agent 1A are observed as indicated by an arrow #14. By repeatedly observing the action a and the observation value o, the time series data of a pair of the action a and the observation value o is obtained and recorded as action time series of an agent A1.

According to a learning algorithm, a difference between the action a* and the action a is determined as a loss l. Furthermore, a reward r is determined by applying the action a to a predetermined reward function. As indicated by a tip of an arrow #15, learning on the basis of the loss l or the reward r is performed, and the policy π₀ is updated.

Examples of the learning algorithm of the imitation learning include the following algorithms.
BC (Behavior Cloning)
DPL (Direct Policy Learning)
IRL (Inverse Reinforcement Learning)

The BC is a supervised learning algorithm using the action time series of the expert. In the BC, each policy is constructed on the basis of the action time series of the expert and the action time series of the apprentice. For example, a difference between the policy π_{φ}* of the expert and the policy π₀ of the apprentice is determined as a loss, and the policy π₀ is adjusted to minimize the loss.

The DPL is an algorithm that updates the policy π₀ with reference to the action time series of the expert. In a DAgger as one type of the DPL, the policy π_{φ}* and the policy π₀ are fused to construct a new policy π. An action time series is generated on the basis of the new policy π, and the policy π₀ is learned.

The IRL is a learning algorithm that estimates a reward function R by using the policy π_{φ}*. Reinforcement learning is performed again by using the reward function R estimated.

Other learning algorithms such as generative adversarial imitation learning (GAIL) may be used. Model-based learning using an environment model for the learning may be performed, or model-free learning in which the learning is performed by using information actually observed in the environment without using the environment model may be performed.

By performing such imitation learning, the policy π_{φ}* of the expert is acquired by the agent 1A.

### <Learning of Policy π_{φ}* by Human Apprentice>

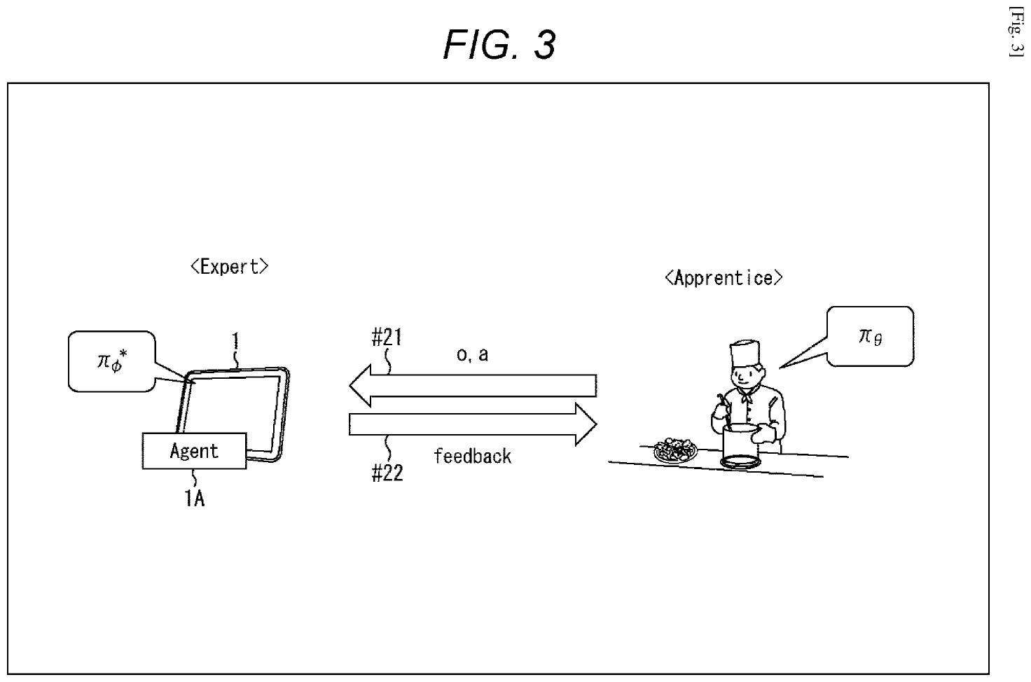

FIG. 3 is a diagram illustrating an example of training by an apprentice.

As illustrated on the left side of FIG. 3, the agent 1A with the policy π_{φ}* acquired is installed in the information processing apparatus 1. The agent 1A with the policy π_{φ}* acquired functions as the expert in the TQA system.

An action generated by the agent 1A as the expert is basically the same as the action performed by the chef in FIG. 1. With the agent A1 as the expert in the imitation learning, training for learning the policy π_{φ}* of the expert is performed by the apprentice.

In the example, the agent 1A as the expert is installed in the information processing apparatus 1 that is the same apparatus as the apparatus used for learning to acquire the policy π_{φ}*, but the agent 1A may be installed in respective different apparatuses. In other words, it is possible to install the agent 1A as the expert in an apparatus different from the information processing apparatus 1 in FIG. 1 used for the learning to acquire the policy π_{φ}*.

For example, the agent 1A as the expert may be installed in a robot capable of performing the same cooking action as the chef. In a case where the agent 1A is installed in a robot provided with, for example, a robot arm, the apprentice can perform the training while watching the cooking action of the robot.

The information processing apparatus 1 may be prepared in the same space as a space where the apprentice performs the cooking action, or may be prepared in a different space. A sensor and a feedback device prepared in the space where the apprentice performs the cooking action are connected to the information processing apparatus 1 via wired or wireless communication.

The apprentice illustrated on the right side of FIG. 3 is a person different from the chef in FIG. 1. The number of the apprentice may be one person, or may be a plurality of persons. In the TQA system, the plurality of the apprentices can simultaneously perform the training.

In a case of learning the policy of the chef who completes the certain dish, the apprentice in FIG. 3 performs a cooking action that imitates the action of the chef in FIG. 1. The action of the apprentice is an action on the basis of the current policy π₀ of the apprentice. The observation value o representing a state of an environment in which the apprentice is cooking and the action a of the apprentice are observed.

The information on the observation value o and the action a is supplied to the information processing apparatus 1 as indicated by an arrow #21, and for example, a difference from the action a* of the agent 1A is determined according to the framework of the imitation learning.

Furthermore, feedback generated according to the difference between the action a* and the action a is provided to the apprentice as indicated by an arrow #22. As the feedback, a stimulus is given for bringing the action a of the apprentice close to the action a*.

In response to the feedback being provided, since the apprentice modifies his/her own action a and remembers the action a*, the policy π₀ of the apprentice is updated to be close to policy π_{φ}* of the agent 1A, that is, the policy π_{φ}* of the chef in FIG. 1.

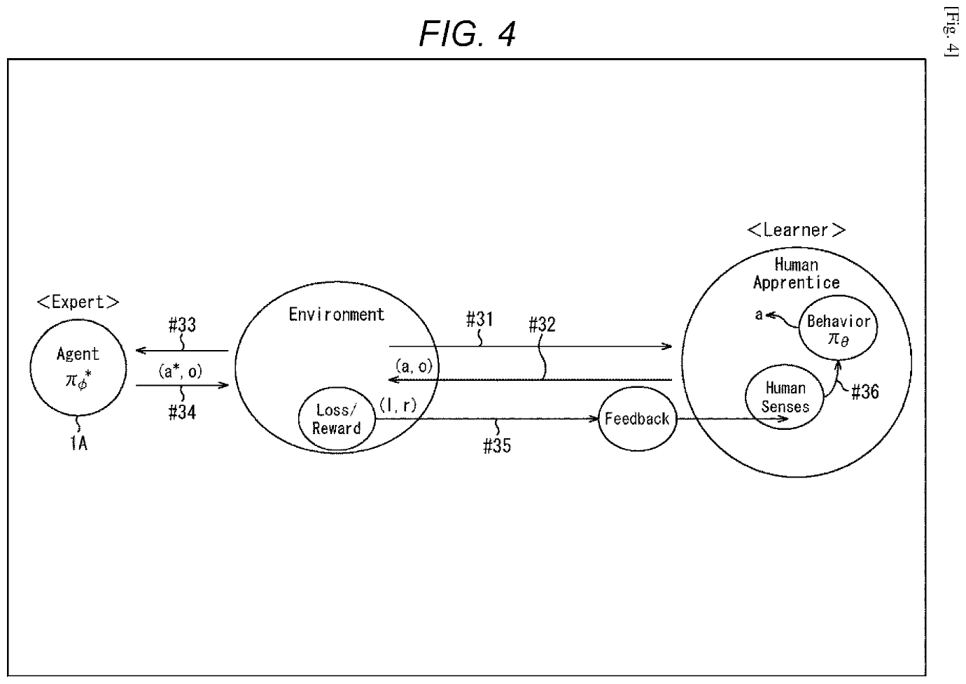

FIG. 4 is a diagram illustrating modeled imitation learning in FIG. 3.

A circle on a left side of FIG. 4 represents the expert (the agent 1A), and a center circle represents the environment in which the apprentice is cooking. A circle on a right side represents the apprentice as a learner.

In response to the apprentice cooking in an environment provided as indicated by an arrow #31, the action a and the observation value o of the apprentice are observed as indicated by an arrow #32. The action a of the apprentice is an action performed in the environment indicated by the observation value o on the basis of the policy π₀. By repeatedly observing the action a and the observation value o, the time series data of the pair of the action a and the observation value o is obtained and recorded as the action time series of the apprentice.

Similarly, the agent 1A generates an action in an environment provided as indicated by an arrow #33. Generation of the action a* of the agent 1A is performed to generate the action in the environment indicated by the observation value o on the basis of the policy π_{φ}*. The action a* and the observation value o of the agent 1A are observed as indicated by an arrow #34. By repeatedly observing the action a* and the observation value o, the time series data of the pair of the action a* and the observation value o is obtained and recorded as the action time series of the agent A1.

According to a learning algorithm, a difference between the action a* and the action a is determined as a loss l. Furthermore, a reward r is determined by applying the action a to a predetermined reward function. As indicated by a tip of an arrow #35, feedback is generated according to the loss l or the reward r and provided to the apprentice.

The policy π₀ of the apprentice is updated to be close to the policy π_{φ}* by the apprentice remembering the action a* in response to the feedback being provided, as indicated by an arrow #36.

Accordingly, in the TQA system to which the present technology is applied, the training for learning the policy π_{φ}* of the expert is implemented by using the framework of the imitation learning. Since the action and the like of the apprentice is observed by using the sensor and the feedback is provided to the apprentice, the quantitative training can be performed.

### <Configuration of TQA System>

Here, components of the TQA system implementing the training as described above will be described.

As for environment

In an environment in which the expert performs an action of a task or the apprentice performs an action imitating the action of the expert, all states related to a learning process are detected by using sensors. A target to be detected includes contents of interference with an environment by the expert or the apprentice.

For example, different physical quantities are detected by the sensor according to the learning process. Furthermore, the TQA evaluation value as the index defined in the TQA system is determined on the basis of the detection result by the sensor such as an RGB camera.

As for sensors

A series of the processing described above in the TQA system is implemented by using the detection result of the state of the environment. The observation value o is determined on the basis of the detection result by the sensor.

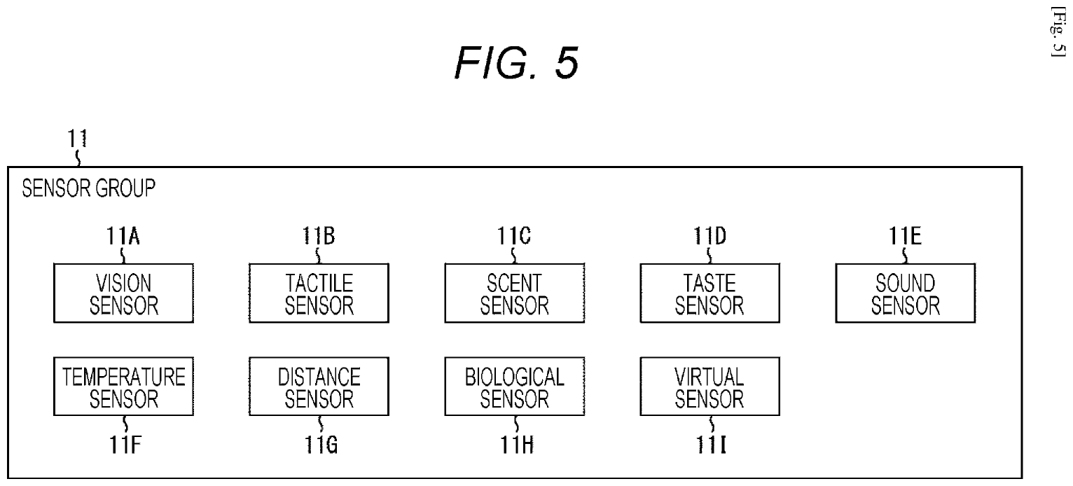

FIG. 5 is a diagram illustrating an example of a sensor.

As illustrated in FIG. 5, a sensor group 11, is used, that includes various sensors such as a vision sensor 11A, a tactile sensor 11B, a scent sensor 11C, a taste sensor 11D, a sound sensor 11E, a temperature sensor 11F, a distance sensor 11G, a biological sensor 11H, and a virtual sensor 11I. A predetermined signal processing is performed on the detection result by each sensor, and the observation value o is determined.

The vision sensor 11A includes, for example, a camera such as an RGB camera or a stereo camera. For example, space recognition is performed on the basis of images imaged by the vision sensor 11A, and the observation value o including a result of the space recognition is determined. Furthermore, the actions of the expert or apprentice are recognized on the basis of the images imaged by the vision sensor 11A.

The tactile sensor 11B includes, for example, a pressure sensor and a touch panel. The tactile sensor 11B detects operations by, for example, a hand of the expert or the apprentice.

For example, in a case where the apprentice is performing a cooking action, the scent sensor 11C detects scents of ingredients being cooked.

For example, in a case where the apprentice is performing the cooking action, the taste sensor 11D detects tastes of the ingredients being cooked. The taste sensor 11D includes sensors that detect respective sweet, salty, sour, bitter, and delicious components.

The sound sensor 11E includes, for example, a microphone, and detects a sound in an environment in which the expert or the apprentice is located.

The temperature sensor 11F detects a temperature of the environment in which the expert or the apprentice is located.

The distance sensor 11G detects a distance to each part of a body of the apprentice and the expert, and detects a distance to each object in the environment in which the expert or the apprentice is located.

The biological sensor 11H detects biological responses of the apprentice and the expert, such as a heart rate, a body temperature, and a blood pressure.

In addition to the physical sensor such as the vision sensor 11A, the virtual sensor 11I is provided. For example, the virtual sensor 11I is used in a case where training of the apprentice is training of actions performed in a game space or a simulator space.

Accordingly, various sensors having a function imitating human senses or a function beyond abilities of the human senses are used to observe the observation value o quantitatively expressing states of the environment and the like. The observation value o is, for example, vector information.

Each sensor is provided with a signal processing module for extracting and calculating information used to generate the observation value o. For example, the vision sensor 11A is provided with the signal processing module for tracking a target object by analyzing the images and outputting a tracking result. The signal processing module for each sensor may be provided inside or outside a housing of the sensor. The signal processing module may be provided in the information processing apparatus 1.

As for feedback device

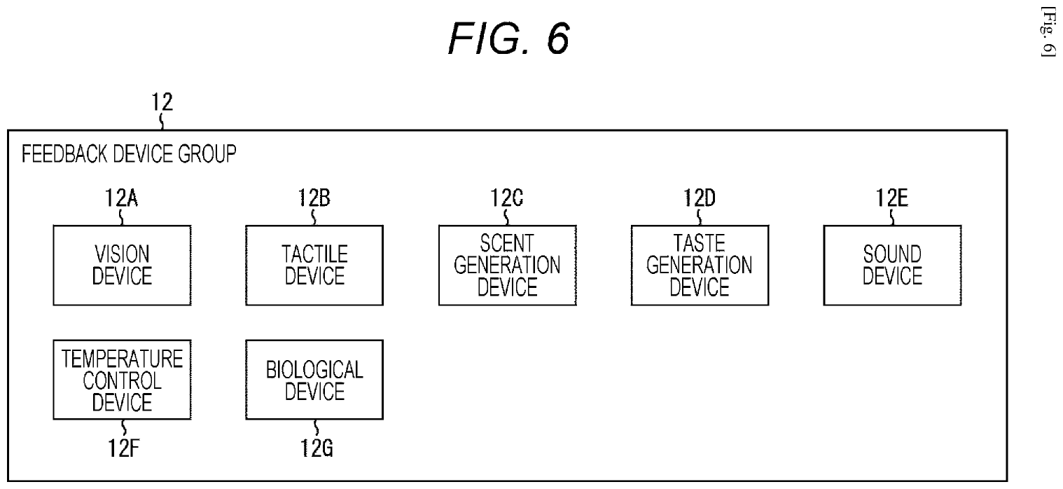

FIG. 6 is a diagram illustrating an example of a feedback device.

As illustrated in FIG. 6, a feedback device group 12, is used, that includes various devices such as a vision device 12A, a tactile device 12B, a scent generation device 12C, a taste generation device 12D, a sound device 12E, a temperature control device 12F, and a biological device 12G. The feedback is provided to the expert or the apprentice on the basis of control information supplied from a feedback generation unit as described later. The feedback provided to the expert and the apprentice may be different feedback, or may be the same feedback.

The vision device 12A includes a device that presents information through vision, such as a display including an LCD, a head mounted display (HMD), and a projector. For example, information as a guide for bringing the actions of the apprentice close to the actions of the expert is displayed by the vision device 12A.

The tactile device 12B includes, for example, a vibration generation device. The tactile device 12B is worn on, for example, the body of the apprentice, and vibration as a guide for bringing the actions of the apprentice close to the actions of the expert is presented by the tactile device 12B.

The scent generation device 12C generates a scent as the guide for bringing the actions of the apprentice close to the actions of the expert.

The taste generation device 12D generates a taste as the guide for bringing the actions of the apprentice close to the actions of the expert.

The sound device 12E includes, for example, a speaker and an earphone. The sound device 12E outputs a sound as the guide for bringing the actions of the apprentice close to the actions of the expert. The sound to be output from the sound device 12E includes various sounds such as voice, music, and sound effects.

The temperature control device 12F generates a temperature as the guide for bringing the actions of the apprentice close to the actions of the expert. The temperature control device 12F is used by being worn on, for example, the body of the apprentice.

The biological device 12G presents information as the guide for bringing the actions of the apprentice close to the actions of the expert, for example, by providing an electric signal to the body of the apprentice and forcibly moving the muscles.

Accordingly, various devices stimulating human senses are used as the feedback devices.

Each feedback device is provided with a signal processing module for generating feedback on the basis of control information supplied from a feedback generation unit that is not illustrated. The signal processing module of each feedback device may be provided inside or outside a housing of the device. The signal processing module may be provided in the information processing apparatus 1.

<First Learning Example (Example to which BC is Applied)>

A specific example of the learning in the TQA system using the framework of the imitation learning will be described.

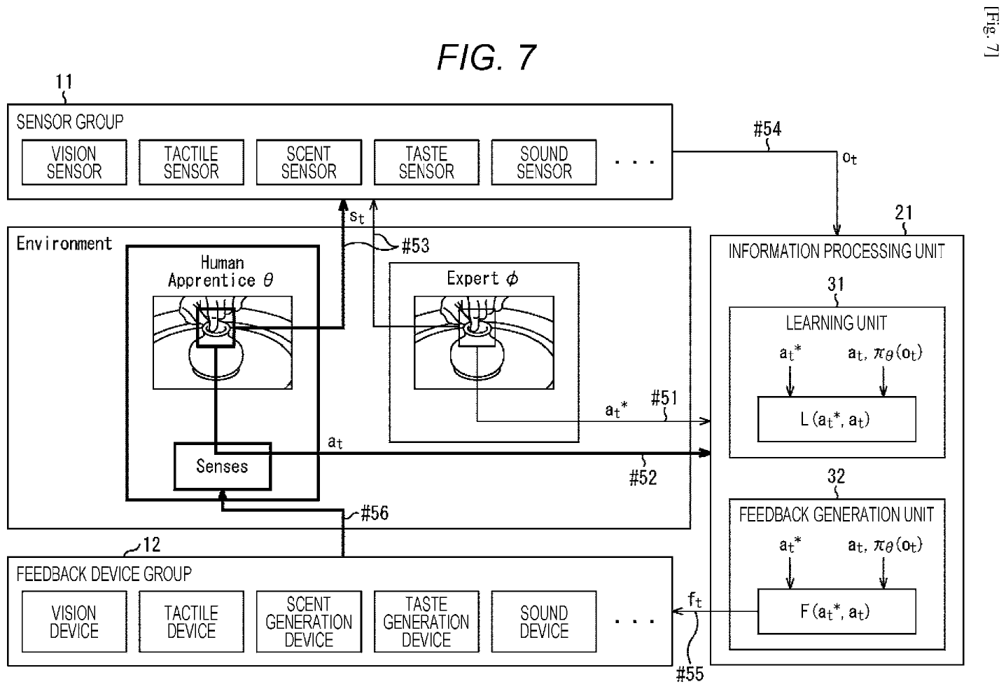

FIG. 7 is a diagram illustrating the first learning example for the apprentice.

In the example of FIG. 7, it is assumed that the expert is a human, and the human expert and a human apprentice are, for example, in the same environment. For example, the training by the apprentice is advanced while the apprentice directly watches the actions related to a predetermined task of the expert and imitates the actions of the expert. In the example of FIG. 7, the task including actions using fingers to form a shape of a small pot is illustrated.

Here, it is assumed that the action a* of the expert can be observed together with the observation value o. The action a* is an optimum action to form the shape of pot. Furthermore, since the expert and the apprentice are in the same environment, the observation value o (an observation value vector [o]₀) in the environment in which the apprentice is located is matched with the observation value o (an observation value vector [o]_{φ}) in the environment in which the expert is located.

The training illustrated in FIG. 7 corresponds to training using the BC in the imitation learning. In the example of FIG. 7, learning in advance for acquiring the policy π_{φ}* as described with reference to FIG. 1 and FIG. 2 is unnecessary.

As illustrated in FIG. 7, the sensor group 11 and the feedback device group 12 are provided in the environment in which the expert and the apprentice are located. In the information processing apparatus 1, an information processing unit 21 is implemented by executing a predetermined program. The information processing unit 21 includes a learning unit 31 and a feedback generation unit 32.

After actions of the task are started, the action aₜ* of the expert is observed and supplied to the information processing unit 21 as indicated by an arrow #51. Furthermore, the action aₜ of the apprentice is observed and supplied to the information processing unit 21 as indicated by an arrow #52.

States sₜ of the environment are detected by the sensor group 11 and supplied to the information processing unit 21 as observation values oₜ as indicated by arrows #53 and #54. Information on the action aₜ* of the expert and the action aₜ of the apprentice is supplied to the information processing unit 21 as, for example, a part of information constituting the observation values oₜ. For example, the action aₜ of the apprentice is observed by comparing the observation values oₜ before and after the apprentice performs the action. The action aₜ is expressed by the following expression (5) by using a function of a policy π₀ (oₜ).

$$\begin{matrix}[ Math . 5 ] & \\ {a}_{t} = {π}_{θ} ( {o}_{t} ) & ( 5 )\end{matrix}$$

In the information processing unit 21, information representing the actions of each of the expert and the apprentice who are humans is obtained together with information on the observation values.

The learning unit 31 of the information processing unit 21 records time series data of a pair of the action aₜ* and the observation values oₜ as the action time series of the expert. Furthermore, the learning unit 31 records the time series data of a pair of the action aₜ and the observation values oₜ as the action time series of the apprentice.

The learning unit 31 calculates a loss lₜ by applying the action aₜ* and the action aₜ to a loss function L. The loss lₜ is expressed by the following expression (6). The loss function L can be arbitrarily set.

$$\begin{matrix}[ Math . 6 ] & \\ {I}_{t} = L ( {a}_{t}^{*} , {π}_{θ} ( {o}_{t} ) ) & ( 6 )\end{matrix}$$

The learning unit 31 updates the policy π₀ on the basis of, for example, the loss lₜ, and records the policy π₀ updated.

The feedback generation unit 32 generates the feedback fₜ by applying the action aₜ* and the action aₜ to a feedback function F, and outputs control information representing the feedback fₜ to the feedback device group 12 as indicated by an arrow #55. The feedback fₜ is expressed by the following expression (7). The feedback function F is a function for determining the feedback fₜ according to the loss lₜ.

$$\begin{matrix}[ Math . 7 ] & \\ {f}_{t} = F ( {a}_{t}^{*} , {π}_{θ} ( {o}_{t} ) ) & ( 7 )\end{matrix}$$

Each feedback device constituting the feedback device group 12 operates according to the feedback fₜ, and outputs feedback for bringing the action aₜ close to the action aₜ* to the apprentice as indicated by an arrow #56. The feedback corresponding to the feedback fₜ is also output to the expert as appropriate.

Accordingly, in the example of FIG. 7, feedback is generated by using the framework of the BC as the imitation learning, and output to the apprentice. The apprentice can acquire the policy π_{φ}* as his/her own policy by continuously providing the feedback that brings his/her own action a close to the action a* of the expert during the training.

In the example of FIG. 7 using the BC, for example, the TQA evaluation value dₜ is calculated on the basis of the loss lₜ and presented by using the vision device 12A. The apprentice who has seen the TQA evaluation value can quantitatively confirm a difference between the action a* of the expert and his/her own action a. The TQA evaluation value d, may be presented by using a feedback device other than the vision device 12A.

The loss lₜ may be presented as the TQA evaluation value dₜ without change, or a value determined by performing a predetermined calculation using the loss lₜ may be presented as the TQA evaluation value dₜ. The policy π_{φ}* may be learned on the basis of the action time series of the expert, and the TQA evaluation value dₜ may be determined on the basis of a difference between the policy π_{φ}* and the policy π₀. Since the action a* of the expert is generated on the basis of the policy π_{φ}* and the action a of the apprentice is generated on the basis of the policy π₀, it can be said that the difference between the policy π_{φ}* and the policy π₀ represents the difference between the action a* and the action a.

The TQA evaluation value dₜ may also be presented to the expert. The expert can confirm how far the training by the apprentice is progressing. In other words, the TQA evaluation value d, can be presented to the apprentice or both the apprentice and the expert.

In a case where the policy π_{φ}* is learned, the training by the apprentice is continued until a predetermined condition is satisfied, for example, the difference between the policy π_{φ}* and the policy π_{φ} becomes smaller than a predetermined difference. In a case where the difference between the policy π_{φ}* and the policy π_{φ} satisfies the predetermined condition, the training by the apprentice ends.

<Second Learning Example (Example to which DPL is Applied)>

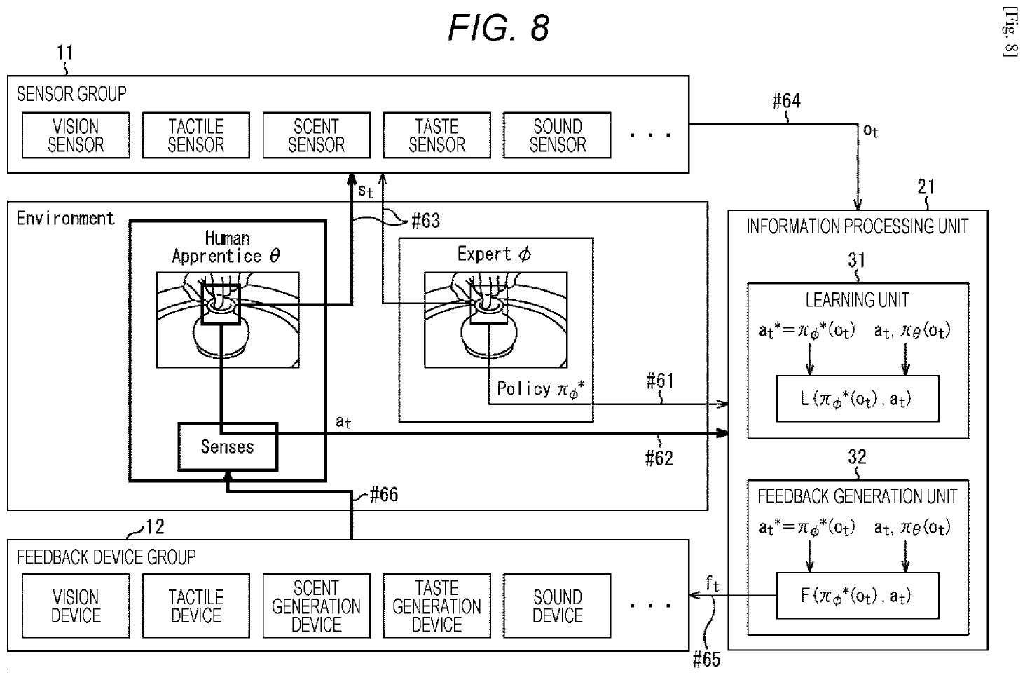

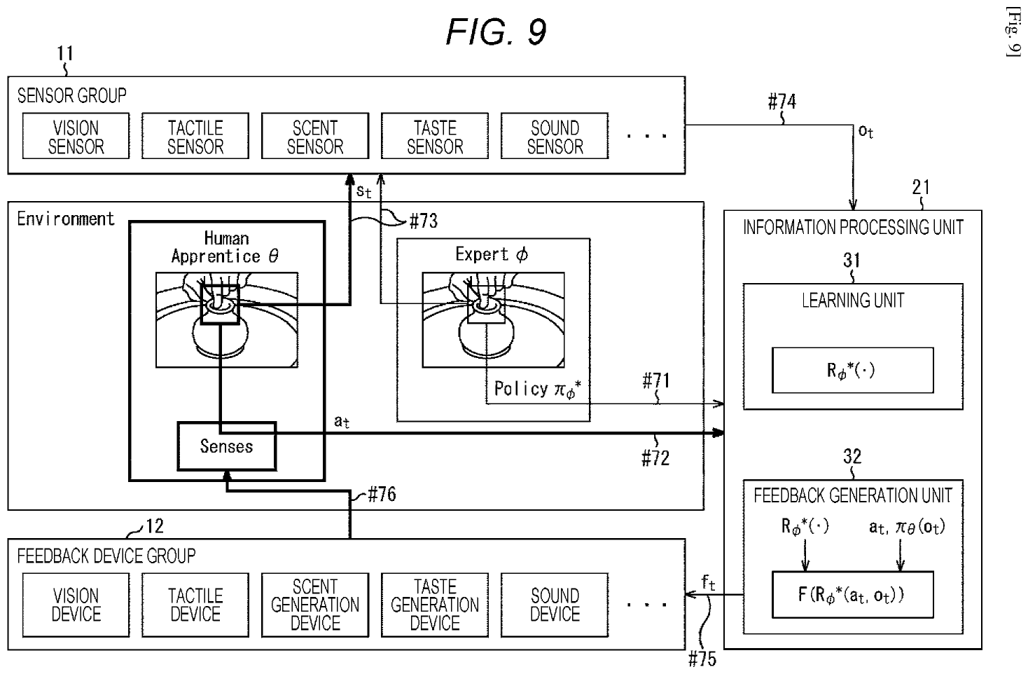

FIG. 8 is a diagram illustrating a second learning example for an apprentice. In the configurations illustrated in FIG. 8, the same configurations as the configurations described with reference to FIG. 7 are denoted by the same reference numerals. Redundant description will be omitted as appropriate. This is similar for FIG. 9 as described later.

In the example of FIG. 8, it is assumed that no expert is in the environment in which the apprentice is located. For example, the training by the apprentice is advanced when the apprentice watches a guide of actions as a demonstration related to a predetermined task and imitates the actions of the expert.

In the example of FIG. 8, the learning for acquiring the policy π_{φ}* as described with reference to FIGS. 1 and 2 is performed, and the policy π_{φ}* is prepared in advance in the learning unit 31 as indicated by an arrow #61. Information on the policy π_{φ}* related to a predetermined task acquired by the imitation learning is obtained by the information processing unit 21 before the training for the apprentice is started. The training illustrated in FIG. 8 corresponds to training using the DPL in the imitation learning.

After the actions of the task are started, the action aₜ of the apprentice is observed and supplied to the information processing unit 21 as indicated by an arrow #62. Furthermore, the states sₜ of the environment are detected by the sensor group 11 and supplied to the information processing unit 21 as the observation values oₜ as indicated by an arrow #63 and an arrow #64. The information on the action aₜ of the apprentice is supplied to the information processing unit 21 as, for example, a part of information constituting the observation values oₜ.

The learning unit 31 of the information processing unit 21 records the time series data of the pair of the action aₜ and the observation values oₜ as the action time series of the apprentice. The action aₜ may be determined in response to calculation as the π₀ (oₜ) by applying the observation values oₜ to the policy π₀ that has been thus acquired, and may be used to record the action time series. Furthermore, the learning unit 31 determines the action aₜ* by applying the observation values oₜ to the policy π_{φ}*, and generates and records the action time series of the expert. The action time series of each of the apprentice and the expert is expressed by the following expressions (8) and (9).

$$\begin{matrix}[ Math . 8 ] & \\ {[ y := {( a , o )}_{t} ]}_{θ} & ( 8 )\end{matrix}$$

$$\begin{matrix}[ Math . 9 ] & \\ {[ y := {( {a}^{*} , o )}_{t} ]}_{ϕ} & ( 9 )\end{matrix}$$

The learning unit 31 calculates a loss lₜ by applying the action aₜ* and the action aₜ to a loss function L. The loss lₜ is expressed by the following expression (10).

$$\begin{matrix}[ Math . 10 ] & \\ {I}_{t} = ( {π}_{Φ}^{*} ( {o}_{t} ) , {π}_{θ} ( {o}_{t} ) ) & ( 10 )\end{matrix}$$

The learning unit 31 updates the policy π₀ on the basis of, for example, the loss lₜ, and records the policy π₀ updated.

The feedback generation unit 32 generates the feedback fₜ by applying the action aₜ* and the action aₜ to the feedback function F, and outputs the control information representing the feedback fₜ to the feedback device group 12 as indicated by an arrow #65. The feedback fₜ is expressed by the following expression (11).

$$\begin{matrix}[ Math . 11 ] & \\ {f}_{t} = F ( {a}_{t} , {π}_{Φ}^{*} ( {o}_{t} ) ) & ( 11 )\end{matrix}$$

Each feedback device constituting the feedback device group 12 operates according to the feedback fₜ, and outputs the feedback for bringing the action aₜ close to the action aₜ* to the apprentice as indicated by an arrow #66.

Accordingly, in the example of FIG. 8, feedback is generated by using the framework of the DPL as the imitation learning, and output to the apprentice. The apprentice can acquire the policy π_{φ}* as his/her own policy by continuously providing the feedback that brings the action a close to the action a* of the expert during the training.

<Third Learning Example (Example to which IRL is Applied)>

FIG. 9 is a diagram illustrating a third learning example for an apprentice.

Also in the example of FIG. 9, it is assumed that no expert is in the environment in which the apprentice is located. For example, the training by the apprentice is advanced when the apprentice watches a guide of actions as a demonstration related to a predetermined task and imitates the actions of the expert.

In the example of FIG. 9, the learning for acquiring the policy π_{φ}* as described with reference to FIGS. 1 and 2 is performed, and the policy π_{φ}* is prepared in advance in the learning unit 31 as indicated by an arrow #71. Information on the policy π_{φ}* related to a predetermined task acquired by the imitation learning is obtained by the information processing unit 21 before the training for the apprentice is started. The training illustrated in FIG. 9 corresponds to training using the IRL in the imitation learning.

After the actions of the task is started, the action aₜ of the apprentice is observed and supplied to the information processing unit 21 as indicated by an arrow #72. Furthermore, the states sₜ of the environment are detected by the sensor group 11 and supplied to the information processing unit 21 as the observation values oₜ as indicated by arrows #73 and #74. The information on the action aₜ of the apprentice is supplied to the information processing unit 21 as, for example, a part of information constituting the observation values oₜ.

The learning unit 31 of the information processing unit 21 records the time series data of the pair of the action aₜ and the observation values oₜ as the action time series of the apprentice. Furthermore, the learning unit 31 determines the action aₜ* by applying the observation values oₜ to the policy π_{φ}*, and generates and records the action time series of the expert.

The learning unit 31 learns the policy π₀ on the basis of the action time series of the apprentice, and calculates a distance (difference) between the policy π_{φ}* and the policy π₀ as the TQA evaluation value dₜ. The distance between the policy π_{φ}* and the policy π₀ is determined by the following expression (12) by using, for example, a KL divergence (D_{KL}) or a JS divergence (D_{JS}).

$$\begin{matrix}[ Math . 12 ] & \\ d = D [ Q ( o , {a}^{*} \vert {π}_{ϕ}^{*} ) \vert \vert Q ( o , a \vert {π}_{θ} ) ] & ( 12 )\end{matrix}$$

The learning unit 31, for example, performs the IRL on the basis of the action time series of the expert and the policy π_{φ}*, and estimates a reward function R_{φ}*. The learning unit 31 outputs information on the reward function R_{φ}* to the feedback generation unit 32. The TQA evaluation value dₜ may be determined on the basis of the reward r estimated by using the reward function R_{φ}*.

The feedback generation unit 32 generates the feedback fₜ by applying the reward function R_{φ}*, the action aₜ, and the observation values oₜ to the feedback function F, and outputs the control information indicating the feedback fₜ to the feedback device group 12 as indicated by an arrow #75. The feedback fₜ is expressed by the following expression (13). The action aₜ may be determined in response to calculation as the π₀ (oₜ) by applying the observation values oₜ to the policy π₀ that has been thus acquired, and may be used to record the action time series.

$$\begin{matrix}[ Math . 13 ] & \\ {f}_{t} = F ( {R}_{ϕ}^{*} ( {a}_{t} , {o}_{t} ) ) & ( 13 )\end{matrix}$$

Each feedback device constituting the feedback device group 12 operates according to the feedback fₜ, and outputs the feedback for bringing the action aₜ close to the action aₜ* to the apprentice as indicated by an arrow #76.

Accordingly, in the example of FIG. 9, feedback is generated by using the framework of the IRL as the imitation learning, and output to the apprentice. The apprentice can acquire the policy π_{φ}* as his/her own policy by continuously providing the feedback that brings the action a close to the action a* of the expert during the training.

### <Details of Feedback Generation>

In the TQA system, the training for the human apprentice is performed unlike the learning for the agent. Since the training target is a human, feedback for human senses is provided.

The feedback needs to be provided to improve performance related to a planning ability, a decision ability, or an execution ability according to the task. The performance is represented by the TQA evaluation value. An advantage of the TQA system is that analysis and optimization are possible since the learning process of the apprentice and a mechanism of the feedback can be formalized.

In the TQA system, two types of feedback, that is, the feedback f as live feedback and the TQA evaluation value d are used. The live feedback is feedback provided to the apprentice who is performing actions by using the feedback device. Note that the TQA evaluation value d can also be said to be feedback in that the TQA evaluation value is calculated by the apprentice performing actions and presented to the apprentice.

The feedback function F is, for example, a function for generating the feedback f according to the difference between the action of the expert and the action of the apprentice. As the feedback f for stimulating the senses of the apprentice, control information for generating vibration of a predetermined pattern or displaying various types of information on the display is generated on the basis of the feedback function F.

For example, in a task related to driving of a racing game, it is assumed that an action of rotating a steering wheel prepared as a control is performed by the apprentice, and a predetermined rotation amount is detected. The rotation amount is detected as a normalized value such as [−1, 1].

In this case, the feedback f is generated for generating vibration having an intensity proportional to the difference between the action of the expert and the action of the apprentice on the steering wheel and provided to the apprentice who is gripping the steering wheel. In this case, a vibration generation device mounted on the steering wheel is used as the feedback device.

Furthermore, a video showing a rotation action of the steering wheel by the expert is generated, and displayed on a screen of the racing game being watched by the apprentice as visual feedback. In this case, the display displaying the screen of the racing game is used as the feedback device.

The TQA evaluation value d representing the difference between the policy π_{φ}* of the expert and the policy π₀ of the apprentice is defined as a quantitative value used to analyze the performance of the apprentice in the learning process. Furthermore, the quantitative value is defined as a value representing quality of skill, such as a performance level of the apprentice.

In a case where the observation values oₜ obtained at each time t are used, the TQA evaluation value dₜ is also expressed as in the following expression (14). The TQA evaluation value dₜ can also be said to be an analysis result of the action time series of the apprentice.

$$\begin{matrix}[ Math . 14 ] & \\ {d}_{t} = D [ Q ( {π}_{ϕ}^{*} ( {o}_{t} ) ) \vert \vert Q ( {π}_{θ} ( {o}_{t} ) ) & ( 14 )\end{matrix}$$

### <Specific Example of Learning Algorithm>

Here, a specific example of the learning (the second learning example) to which the DPL is applied will be described.

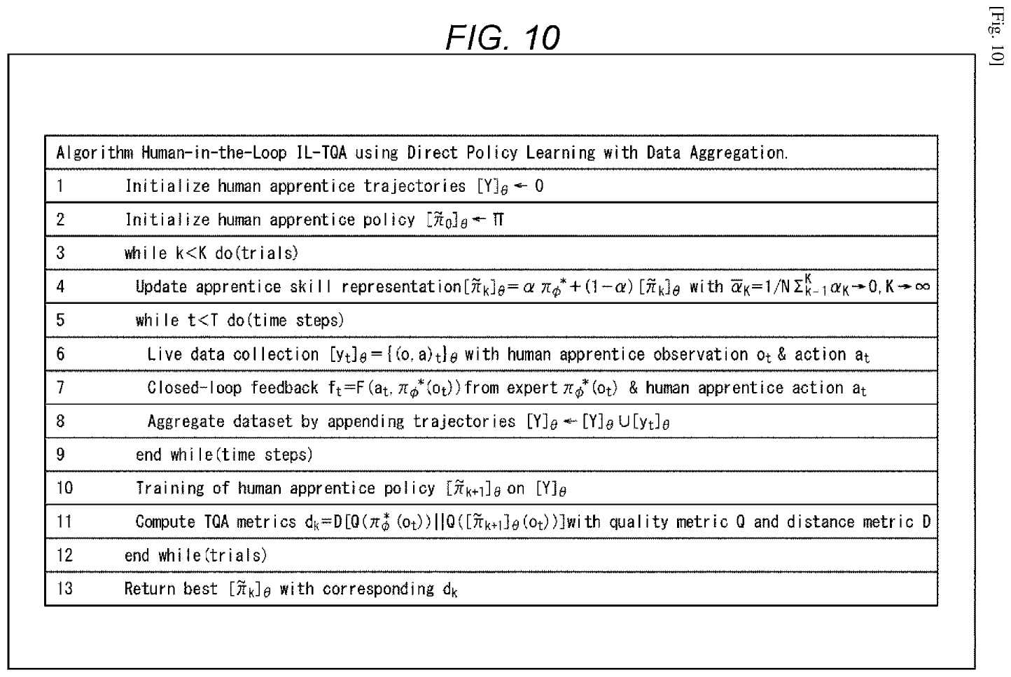

FIG. 10 is a diagram illustrating an example of a DPL algorithm in a case where a DAgger is used. The processing of each step will be described by using row numbers illustrated at a left end of FIG. 10. Here, it is assumed that the policy π_{φ}* of the expert acquired by the imitation learning appropriately represents the policy of the expert such as the cook.

In step S1, the action time series of the apprentice is initialized. The initialization of the action time series of the apprentice is expressed by the following expression (15).

$$\begin{matrix}[ Math . 15 ] & \\ {[ Y ]}_{θ} ← 0 & ( 15 )\end{matrix}$$

In step S2, the policy π₀ of the apprentice is initialized by using a predetermined policy. The initialization of the policy π₀ is expressed by the following expression (16). The suffix 0 represents a trial number k of the learning of the policy π₀.

$$\begin{matrix}[ Math . 16 ] & \\ {[ {\tilde{π}}_{0} ]}_{θ} ← \prod & ( 16 )\end{matrix}$$

After the action time series of the apprentice and the policy π₀ are initialized, the following processing is repeated K times as illustrated in step S3.

In step S4, the policy π₀ of the apprentice is updated. The update of the policy π₀ is expressed by the following expression (17) by using the policy π_{φ}*. α in the expression (17) is determined, for example, on the basis of an initial value of the TQA evaluation value d.

$$\begin{matrix}[ Math . 17 ] & \\ {[ {\tilde{π}}_{k} ]}_{θ} = {απ}_{ϕ}^{*} + {( 1 - α ) [ {\tilde{π}}_{k} ]}_{θ} & ( 17 )\end{matrix}$$

Processing after step S5 is loop processing for collecting the action time series yₜ at each time t and providing feedback to the apprentice.

In step S6, the action aₜ and the observation values oₜ are observed on the basis of a detection result of the sensor group 11. A pair of the action aₜ and the observation values oₜ is obtained as a sample yₜ constituting the action time series of the apprentice. yₜ is represented by the following expression (18).

$$\begin{matrix}[ Math . 18 ] & \\ {[ {y}_{t} ]}_{θ} = {\{ {( o , a )}_{t} \}}_{θ} & ( 18 )\end{matrix}$$

In step S7, the feedback fₜ is determined on the basis of the action aₜ and the observation values oₜ, and the feedback is provided to the apprentice by the feedback device group 12. The feedback fₜ is expressed by the following expression (19).

$$\begin{matrix}[ Math . 19 ] & \\ {f}_{t} = F ( {a}_{t} , {π}_{ϕ}^{*} ( {o}_{t} ) ) & ( 19 )\end{matrix}$$

The feedback function F of the expression (19) is a function that generates feedback according to the difference between the action aₜ* determined by applying the observation values oₜ to the policy π_{φ}* and the action ar.

In step S8, the sample yₜ is added to an action time series [Y]₀, and the action time series [Y]₀ is updated. The update of the action time series [Y]₀ is expressed by the following expression (20).

$$\begin{matrix}[ Math . 20 ] & \\ {[ Y ]}_{θ} ← {[ Y ]}_{θ} ⋃ {[ {y}_{t} ]}_{θ} & ( 20 )\end{matrix}$$

The processing of steps S6 to S8 performed at each time t is repeated, for example, for a time period T as a predetermined time period (step S5).

After the processing of steps S6 to S8 is repeatedly performed during the time period T, in step S10, learning of the policy π₀ ([π⁻ₖ₊₁]₀) is performed on the basis of the action time series [Y]₀ as a data set thus obtained. The action time series [Y]₀ is data that best represents a current skill level of the apprentice. The action time series [Y]₀ includes information on an adaptive action performed by the apprentice according to the feedback continuously provided.

In step S11, the TQA evaluation value di is determined and presented. The TQA evaluation value dₖ is expressed by the following expression (21).

$$\begin{matrix}[ Math . 21 ] & \\ {d}_{k} = D [ Q ( {π}_{ϕ}^{*} ( {o}_{t} ) ) \vert \vert Q ( {[ {\tilde{π}}_{k + 1} ]}_{θ} ( {o}_{t} ) ) ] & ( 21 )\end{matrix}$$

After the processing of steps S4 to S11 is repeated K times (step S3), in step S13, for example, the policy [π⁻ₖ₊₁]₀ having a highest TQA evaluation value dₖ is recorded. Thereafter, the series of the learning processing ends.

Accordingly, the learning process for the human apprentice and the learning process of the DPL that aggregates the action time series and learns the policy π₀ are similar processes. The learning process using the DPL can be applied to the learning process for the human apprentice.

Note that, among the above processes, the process of step S7 is a process executed by the feedback generation unit 32. The processing other than that in step S7 is processing executed by the learning unit 31.

### <Application Example of Learning Using DPL>

Here, training in a case where the human apprentice learns the policy π_{φ}* of the expert related to a video game will be described.

In the TQA system, for example, the AI agent learned the policy π_{φ}* of the expert of the racing game is prepared. Examples of such AI agent include Gran Turismo Sophy (trademark) (https://www.gran-turismo.com/jp/gran-turismo-sophy/). During the training, feedback, which is generated on the basis of the policy π_{φ}* and is for winning a race, is provided to the apprentice.

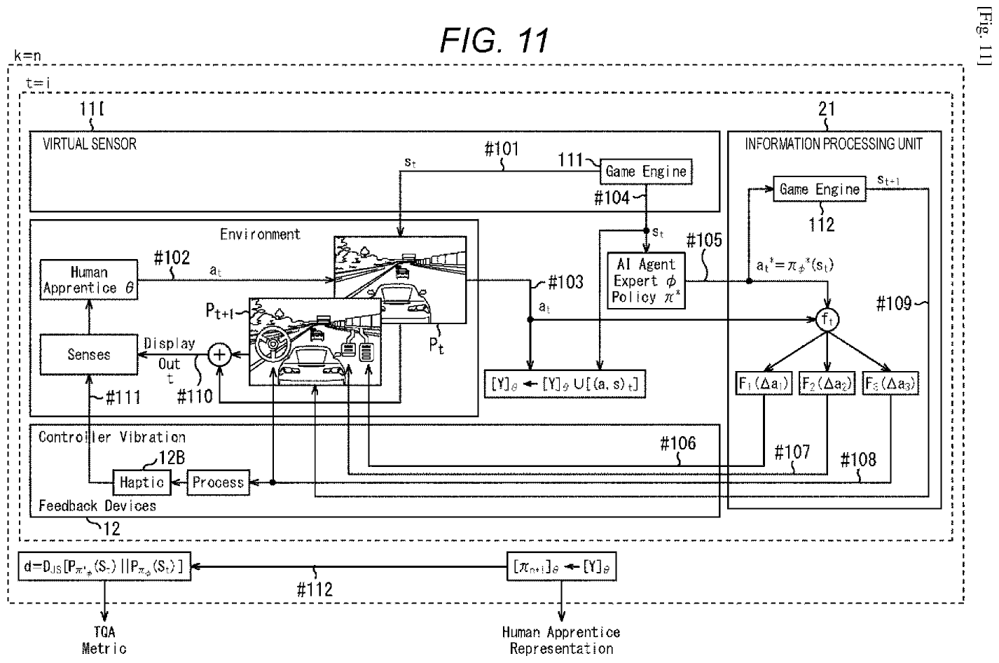

FIG. 11 is a diagram illustrating a flow of learning using a DPL.

As illustrated in an upper part of FIG. 11, the virtual sensor 11I is used as a sensor that observes a state s of an environment in which the apprentice plays the racing game. The virtual sensor 11I includes a game engine 111. The game engine 111 generates a state sₜ according to progress of the racing game and functions as the virtual sensor that detects the state. The state sₜ generated by the game engine 111 corresponds to the observation values oₜ.

On the basis of the state sₜ generated by the game engine 111, a screen Pₜ of the racing game is displayed as indicated by a tip of an arrow #101. The apprentice as a learner performs actions aₜ by watching the screen Pₜ displayed on the display (an arrow #102).

The actions aₜ include a plurality of actions such as an action of rotating the steering wheel to move the own vehicle body, an action of stepping on an accelerator pedal, and an action of stepping on a brake pedal. These actions may be performed by using the steering wheel, the accelerator pedal, or the brake pedal physically prepared as a control device for simulation, or may be performed by using a control provided with a cross key or button.

Information on the action aₜ is supplied to the information processing unit 21, and used to record the action time series [Y]₀ of the apprentice (an arrow #103). Information on the state sₜ generated by the game engine 111 is also used to record the action time series [Y]₀ (an arrow #104).

On the other hand, by applying the state sₜ generated by the game engine 111, the action aₜ* is generated by the AI agent having the policy π_{φ}*. The actions aₜ also include the plurality of the actions such as the action of rotating the steering wheel to move the vehicle body, the action of stepping on the accelerator pedal, and the action of stepping on the brake pedal. Information on the action aₜ* is supplied to the information processing unit 21 (an arrow #105).

In the information processing unit 21, the feedback fₜ as the live feedback according to a difference Δaᵢ between the respective actions is generated on the basis of the action aₜ* and the action ar.

In the example of FIG. 11, feedback F₁ (Δa₁) is generated as the feedback fₜ related to the action of stepping on the accelerator pedal, and feedback F₂ (Δa₂) is generated as the feedback fₜ related to the action of stepping on the brake pedal. Furthermore, feedback F₃ (Δa₃) is generated as the feedback fₜ related to the rotation of the steering wheel.

As indicated by tips of arrows #106 to #108, information as a guide for each of the action of stepping on the accelerator pedal, the action of stepping on the brake pedal, and the rotational action of the steering wheel is arranged on a screen Pₜ₊₁ as a screen at time t+1 on a basis of the feedback F₁ (Δa₁), F₂ (Δa₂), and F₃ (Δa₃). The screen Pₜ₊₁ is a screen representing a state sₜ₊₁ generated by the game engine 112 in response to the action aₜ* (an arrow #109).

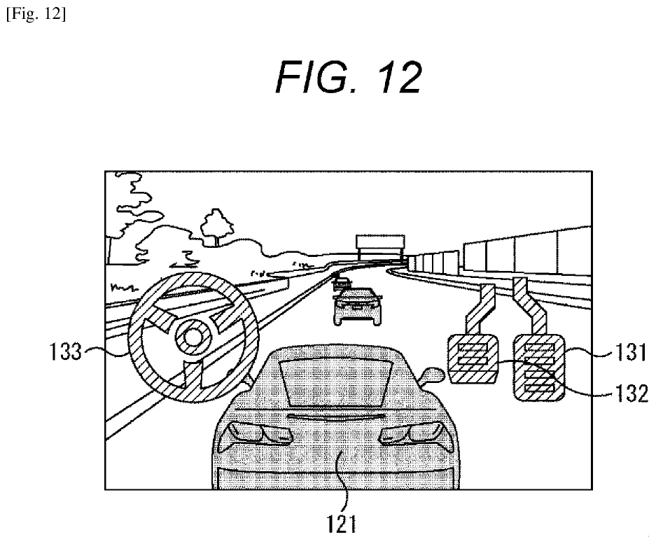

FIG. 12 is an enlarged diagram illustrating the screen Pₜ₊₁.

A vehicle body 121 to be operated is displayed as indicated by adding a color to substantially a center of the screen Pₜ₊₁. On a right side of the screen Pₜ₊₁, an icon 131 indicating the accelerator pedal and an icon 132 indicating the brake pedal are arranged. Furthermore, on a left side of the screen Pₜ₊₁, an icon 133 indicating the steering wheel is arranged. The icons 131 to 133 are arranged, for example, to be superimposed on the video of the racing game.

A correction amount of the accelerator pedal is presented by the icon 131 on the basis of the feedback F₁ (Δa₁), and a correction amount of the brake pedal is presented by the icon 132 on the basis of the feedback F₂ (Δa₂). Furthermore, a correction amount of the steering wheel is presented by the icon 133 on the basis of the feedback F₃ (Δa₃). For example, display of the icon 131 is a display indicating the action to be close to the action (the operation) of the accelerator pedal of the AI agent.

Returning to the description of FIG. 11, as indicated by a tip of an arrow #110, a screen in which the screen Pₜ₊₁ is superimposed on the screen Pₜ is displayed, therefore, feedback using the vision device 12A is performed. The vehicle body 121 on the screen Pₜ₊₁ is displayed on the screen Pₜ as a so-called ghost car indicating a state of the vehicle body in response to the action aₜ* ahead one time.

By displaying the information on the state sₜ₊₁ to be superimposed on the screen Pₜ, it is possible to provide detailed insight related to the most suitable a race strategy to the apprentice, and make a plan one time ahead in advance.

As indicated by a tip of an arrow #111, in the example of FIG. 11, feedback using the tactile device 12B is provided as the feedback F₃ (Δa₃). For example, the apprentice can recognize a rotation correction amount of the steering wheel by vibration applied to a hand gripping the steering wheel. Accordingly, the feedback is output to the apprentice by using a plurality of types of feedback devices.

Such series of the processing is repeatedly performed at each time t. On the basis of the action time series [Y]₀ accumulated during iterative processing (time T), a policy π_{Θ} is learned as illustrated in a lower part of FIG. 11. Furthermore, as indicated by a tip of an arrow #112, the TQA evaluation value d is determined on the basis of the policy π_{φ}* and the policy π_{Θ} learned, and presented to the apprentice.

By presenting the TQA evaluation value, the apprentice can recognize a difference in skill from the AI agent.

The training as described above in the TQA system can also be applied to the training in the case of learning the policy π_{φ}* related to video games other than the racing game. In addition to the video game, the training in the case of learning the policy π_{φ}* for various tasks performed with an actions on a virtual space is also applicable.

### MODIFICATION EXAMPLES

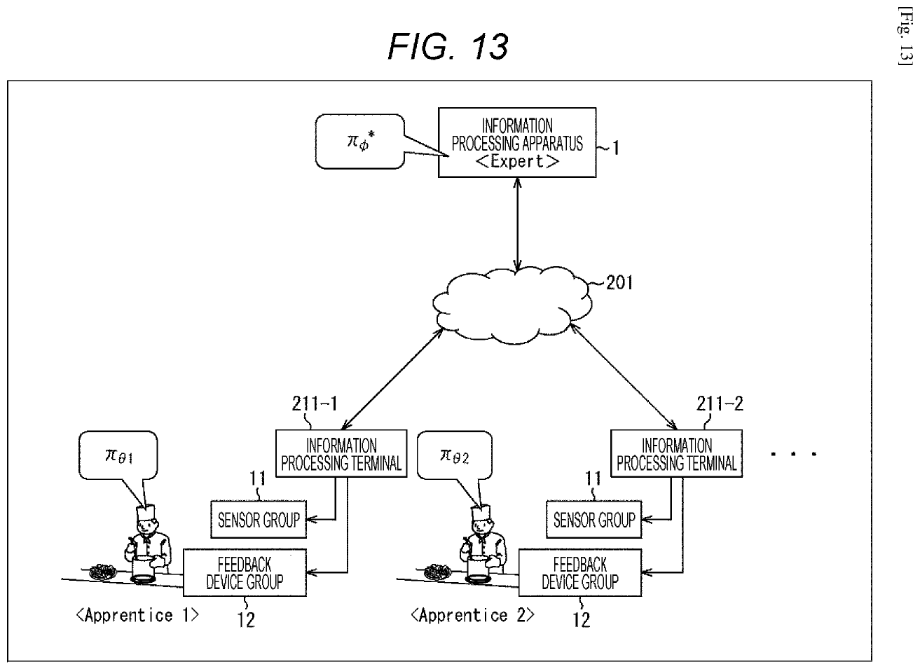

FIG. 13 is a diagram illustrating another configuration example of a TQA system.

In the example of FIG. 13, the information processing apparatus 1 that has acquired the policy π_{φ}* of the expert related to a predetermined task is prepared as a server on a network 201. The information processing apparatus 1 provides the training for a plurality of apprentices via the network 201 such as the Internet.

FIG. 13 illustrates two apprentices, that is an apprentice 1 and an apprentice 2, but more apprentices also can be trained. Training for the same task may be performed simultaneously by the plurality of the apprentices, or may be performed at different timings.

As illustrated in FIG. 13, an information processing terminal 211-1 is prepared as a terminal used by the apprentice 1 for learning, and an information processing terminal 211-2 is prepared as a terminal used by the apprentice 2 for learning. The sensor group 11 and the feedback device group 12 are connected to the information processing terminal 211-1 and the information processing terminal 211-2, respectively.

The information processing apparatus 1 communicates with the information processing terminals used by each apprentice, including the information processing terminal 211-1 and the information processing terminal 211-2. For example, the information processing apparatus 1 receives the information on the action aₜ of the apprentice 1 and the observation values oₜ transmitted from the information processing terminal 211-1, and generates feedback to the apprentice 1 as described above. The information processing apparatus 1 transmits control information representing content of the feedback to the information processing terminal 211-1.

The information processing terminal 211-1 that has received the control information transmitted from the information processing apparatus 1 drives the feedback device group 12, and outputs the feedback to the apprentice 1. Processing similar to the above processing is also performed between the information processing apparatus 1 and the information processing terminal 211-2.

Accordingly, the training for the plurality of the apprentices can be performed in the TQA system.

### Configuration Example of Computer

A series of the processing described above can be executed by hardware, or may be executed by software. In a case where the series of the processing is executed by software, a program included in the software is installed from a program recording medium to, for example, a computer incorporated in dedicated hardware, or a general-purpose personal computer.

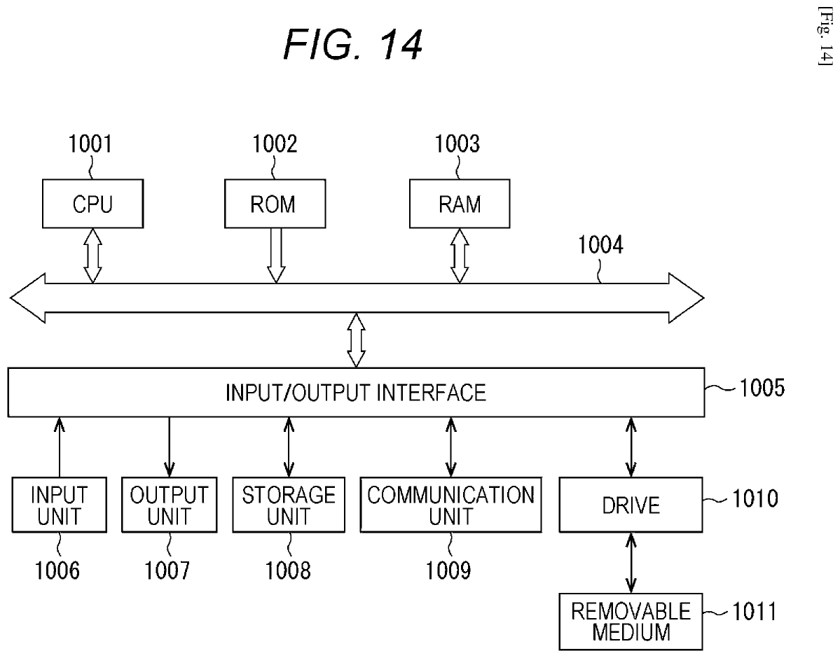

FIG. 14 is a block diagram illustrating a configuration example of hardware of a computer executing the series of the processing described above by a program. The information processing apparatus 1 has a configuration similar to the configuration illustrated in FIG. 14.

A central processing unit (CPU) 1001, a read only memory (ROM) 1002, and a random access memory (RAM) 1003 are interconnected via a bus 1004.

An input/output interface 1005 is further connected to the bus 1004. The input/output interface 1005 is connected with an input unit 1006 including, for example, a keyboard and a mouse, and an output unit 1007 including, for example, a display and a speaker. Furthermore, the input/output interface 1005 is connected with a storage unit 1008 including, for example, a hard disk and a non-volatile memory, a communication unit 1009 including, for example, a network interface, and a drive 1010 driving a removable medium 1011.

In the computer configured as described above, for example, the CPU 1001 loads a program stored in the storage unit 1008 into the RAM 1003 via the input/output interface 1005 and the bus 1004 and executes the program, to perform the series of the processing described above.

For example, the program to be executed by the CPU 1001 is recorded in the removable medium 1011 or provided via a wired or wireless transmission medium such as a local area network, the Internet, or a digital broadcast, and installed in the storage unit 1008.

The program to be executed by the computer may be a program in which processing is performed in time series in an order described in the present description, or may be a program in which processing is performed in parallel or at a necessary timing, for example, when a call is made.

In the present description, the system means a set of a plurality of components (apparatuses or modules (parts) and the like), and it does not matter whether or not all the components are located in the same housing. Therefore, a plurality of apparatuses housed in separate housings and connected via the network and one apparatus in which a plurality of modules is housed in one housing are both systems.

The effects described in the present description are merely examples and are not limited, and other effects may be provided.

Embodiments of the present technology are not limited to the embodiments described above, and various modifications can be made without departing from the gist of the present technology.

For example, the present technology may be configured as cloud computing in which one function is shared by a plurality of apparatuses via the network to make collaborative processing.

Furthermore, each step described in the flowchart described above can be executed by one apparatus or executed by a plurality of apparatuses in a shared manner.

Moreover, in a case where a plurality of processing is included in one step, the plurality of the processing included in the one step can be executed by one apparatus or by a plurality of apparatuses in a shared manner.

### Combination Example of Configurations

The present technology can also employ the following configurations:

(1)

An information processing apparatus, comprising processing circuitry configured to receive information corresponding to actions of a task by a first human, generate feedback by using a framework of imitation learning, the feedback indicating changes to the received actions of the task, the indicated changes being based on actions of a second human performing the task, and
output information corresponding to the feedback to the first human who is performing the actions of the task.

(2)

The information processing apparatus according to (1), wherein the processing circuitry is further configured to
repeatedly output the feedback while the first human is performing the actions of the task.

(3)

The information processing apparatus according to (1) or (2), wherein the processing circuitry is further configured to
obtain an observation value representing the actions of the first human and representing a state of an environment in which the first human performs the actions based on a detection result by a sensor.

(4)

The information processing apparatus according to (3), wherein the processing circuitry is further configured to
identify a policy of the first human related to the task based on the actions of the first human and the time series data of the observation value.

(5)

The information processing apparatus according to (4), wherein the processing circuitry is further configured to
end training for the first human in a case where the policy of the first human satisfies predetermined conditions.

(6)

The information processing apparatus according to any one of (1) to (5), wherein the processing circuitry is further configured to
provide an evaluation value according to a difference between the action of the first human and the action of the second human to the first human or to the first human and the second human.

(7)

The information processing apparatus according to (1), wherein the processing circuitry is further configured to
receive the information corresponding to the actions of the task by the second human together with the actions of the first human, and
generate the feedback according to a difference between the action of the first human and the action of the second human by using a framework of behavior cloning as the imitation learning.

(8)

The information processing apparatus according to (7), wherein the processing circuitry is further configured to
obtain an observation value representing the actions of each of the first human and the second human and representing a state of an environment in which the first human and the second human perform the actions based on the detection result by the sensor.

(9)

The information processing apparatus according to (8), wherein the processing circuitry is further configured to
identify the policy of the first human related to the task based on the actions of the first human and the time series data of the observation value, and
identify the policy of the second human related to the task based on the actions of the second human and the time series data of the observation value.

(10)

The information processing apparatus according to (3), wherein the processing circuitry is further configured to
obtain the policy of the second human related to the task acquired by the imitation learning before the training for the first human is started.

(11)

The information processing apparatus according to (10), wherein the processing circuitry is further configured to
generate the feedback according to the difference between the action of the first human and the action of the second human determined to apply the observation value to the policy of the second human, using a framework of direct policy learning as the imitation learning.

(12)

The information processing apparatus according to (11), wherein the processing circuitry is further configured to
identify the policy of the first human related to the task based on the actions of the first human and the time series data of the observation value, and
calculate the evaluation value based on the policy of the first human and the policy of the second human and provide the evaluation value to the first human or the first human and the second human.

(13)

The information processing apparatus according to (10), wherein the processing circuitry is further configured to
estimate a reward function based on the policy of the second human and the actions of the second human by using a framework of inverse reinforcement learning as the imitation learning, and
generate the feedback according to a reward determined by applying the actions of the first human and the observation value to the reward function.

(14)

The information processing apparatus according to (13), wherein the processing circuitry is further configured to
identify the policy of the first human related to the task based on the actions of the first human and the time series data of the observation value, and
calculate the evaluation value based on the policy of the first human and the policy of the second human and provide the evaluation value to the first human or the first human and the second human.

(15)

The information processing apparatus according to any one of (1) to (14), wherein the processing circuitry is further configured to
output the feedback by controlling at least one of a first device to be worn by the first human or a second device in an environment in which the first human performs the actions of the task.

(16)

The information processing apparatus according to (15), wherein the processing circuitry is further configured to
control at least one of the first device or the second device to provide a stimulus to a sense of touch of the first human.

(17)

An information processing method, comprising
receiving information corresponding to actions of a task by a first human;
generating feedback by using a framework of imitation learning, the feedback indicating changes to the received actions of the task, the indicated changes being based on actions of a second human performing the task; and
outputting information corresponding to the feedback to the first human who is performing the actions of the task.

(18)

A non-transitory computer-readable storage medium storing computer-readable instructions thereon which, when executed by a computer, cause the computer to perform a method, the method comprising:
receiving information corresponding to actions of a task by a first human; and
generating feedback by using a framework of imitation learning, the feedback indicating changes to the received actions of the task, the indicated changes being based on actions of a second human performing the task; and
outputting information corresponding to the feedback to the first human who is performing the actions of the task.

(19)

A system, comprising
a server; and
one or more information processing apparatuses communicably coupled to the server, each of the one or more information processing apparatuses including processing circuitry configured to
receive information corresponding to actions of a task by a first human, transmit the information corresponding to the actions of the task to the server, receive, from the server, feedback generated at the server by using a framework of imitation learning, the feedback indicating changes to the received actions of the task, the indicated changes being based on actions of a second human performing the task, and
output information corresponding to the feedback to the first human who is performing the actions of the task.

(20)

The information processing apparatus according to (1) to (16), wherein the processing circuitry for outputting information corresponding to the feedback is further configured to
transmit an electrical stimulus to a muscle of the first human to move the muscle of the first human in a predetermined direction based on the feedback.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Information processing apparatus
11 Sensor group
12 Feedback device group
21 Information processing unit
31 Learning unit
32 Feedback generation unit
111 Game Engine

1. An information processing apparatus, comprising:
processing circuitry configured to
receive information corresponding to actions of a task by a first human, generate feedback by using a framework of imitation learning, the feedback indicating changes to the received actions of the task, the indicated changes being based on actions of a second human performing the task, and
output information corresponding to the feedback to the first human who is performing the actions of the task.

2. The information processing apparatus according to claim 1, wherein the processing circuitry is further configured to
repeatedly output the feedback while the first human is performing the actions of the task.

3. The information processing apparatus according to claim 1, wherein the processing circuitry is further configured to
obtain an observation value representing the actions of the first human and representing a state of an environment in which the first human performs the actions based on a detection result by a sensor.

4. The information processing apparatus according to claim 3, wherein the processing circuitry is further configured to
identify a policy of the first human related to the task based on the actions of the first human and the time series data of the observation value.

5. The information processing apparatus according to claim 4, wherein the processing circuitry is further configured to
end training for the first human in a case where the policy of the first human satisfies predetermined conditions.

6. The information processing apparatus according to claim 1, wherein the processing circuitry is further configured to
provide an evaluation value according to a difference between the action of the first human and the action of the second human to the first human or to the first human and the second human.

7. The information processing apparatus according to claim 1, wherein the processing circuitry is further configured to
receive the information corresponding to the actions of the task by the second human together with the actions of the first human, and
generate the feedback according to a difference between the action of the first human and the action of the second human by using a framework of behavior cloning as the imitation learning.

8. The information processing apparatus according to claim 7, wherein the processing circuitry is further configured to
obtain an observation value representing the actions of each of the first human and the second human and representing a state of an environment in which the first human and the second human perform the actions based on the detection result by the sensor.

9. The information processing apparatus according to claim 8, wherein the processing circuitry is further configured to
identify the policy of the first human related to the task based on the actions of the first human and the time series data of the observation value, and
identify the policy of the second human related to the task based on the actions of the second human and the time series data of the observation value.

10. The information processing apparatus according to claim 3, wherein the processing circuitry is further configured to
obtain the policy of the second human related to the task acquired by the imitation learning before the training for the first human is started.

11. The information processing apparatus according to claim 10, wherein the processing circuitry is further configured to
generate the feedback according to the difference between the action of the first human and the action of the second human determined to apply the observation value to the policy of the second human, using a framework of direct policy learning as the imitation learning.

12. The information processing apparatus according to claim 11, wherein the processing circuitry is further configured to
identify the policy of the first human related to the task based on the actions of the first human and the time series data of the observation value, and
calculate the evaluation value based on the policy of the first human and the policy of the second human and provide the evaluation value to the first human or the first human and the second human.

13. The information processing apparatus according to claim 10, wherein the processing circuitry is further configured to
estimate a reward function based on the policy of the second human and the actions of the second human by using a framework of inverse reinforcement learning as the imitation learning, and
generate the feedback according to a reward determined by applying the actions of the first human and the observation value to the reward function.

14. The information processing apparatus according to claim 13, wherein the processing circuitry is further configured to
identify the policy of the first human related to the task based on the actions of the first human and the time series data of the observation value, and
calculate the evaluation value based on the policy of the first human and the policy of the second human and provide the evaluation value to the first human or the first human and the second human.

15. The information processing apparatus according to claim 1, wherein the processing circuitry is further configured to
output the feedback by controlling at least one of a first device to be worn by the first human or a second device in an environment in which the first human performs the actions of the task.

16. The information processing apparatus according to claim 15, wherein the processing circuitry is further configured to
control at least one of the first device or the second device to provide a stimulus to a sense of touch of the first human.

17. An information processing method, comprising:
receiving information corresponding to actions of a task by a first human;
generating feedback by using a framework of imitation learning, the feedback indicating changes to the received actions of the task, the indicated changes being based on actions of a second human performing the task; and
outputting information corresponding to the feedback to the first human who is performing the actions of the task.

18. A non-transitory computer-readable storage medium storing computer-readable instructions thereon which, when executed by a computer, cause the computer to perform a method, the method comprising:
receiving information corresponding to actions of a task by a first human; and
generating feedback by using a framework of imitation learning, the feedback indicating changes to the received actions of the task, the indicated changes being based on actions of a second human performing the task; and
outputting information corresponding to the feedback to the first human who is performing the actions of the task.

19. A system, comprising:
a server; and
one or more information processing apparatuses communicably coupled to the server, each of the one or more information processing apparatuses including processing circuitry configured to receive information corresponding to actions of a task by a first human, transmit the information corresponding to the actions of the task to the server,
receive, from the server, feedback generated at the server by using a framework of imitation learning, the feedback indicating changes to the received actions of the task, the indicated changes being based on actions of a second human performing the task, and
output information corresponding to the feedback to the first human who is performing the actions of the task.

20. The information processing apparatus of claim 1, wherein the processing circuitry for outputting information corresponding to the feedback is further configured to
transmit an electrical stimulus to a muscle of the first human to move the muscle of the first human in a predetermined direction based on the feedback.
